(19) United States
(12) Patent Application Publication
(10) Pub. No.: US 2013/0097060 A1
(43) Pub. Date: Apr. 18, 2013

(54) Educational and Game-Based Banking Application whereby Youth Earn Real Money toward Specific Savings, Spending and Charity Goals

(71) Applicant: David Paul Taylor, San Jose, CA (US)

(72) Inventor: David Paul Taylor, San Jose, CA (US)

(73) Assignee: David Paul Taylor, San Jose, CA (US)

(21) Appl. No.: 13/644,873

(22) Filed: Oct. 4, 2012

Related U.S. Application Data
(60) Provisional application No. 61/543,300, filed on Oct. 4, 2011.

(51) Int. Cl. G06Q 40/00

(52) U.S. Cl. CPC G06Q 40/00
USPC 705/35

(57) ABSTRACT

A money management method that teaches financial literacy is described. An account owner—including but not limited to a parent, grandparent, or legal guardian—makes money available to be earned through the system. An account beneficiary—including but not limited to a minor under the age of 18—earns money by completing a series of educational lessons and games (known in the system as “challenges”). Once earned, money is allocated by the beneficiary to specific savings, spending, and charity goals (known as “funds”). The amount of money earned for a given challenge is dependent upon the goal (“fund”) to which it is allocated. Account owners can make additional moneys available (known as a “match”) for specific savings and charity goals. Funds integrate on the back-end with traditional financial products—including but not limited to checking, savings, 529 and/or Prepaid accounts. The system is managed on web, mobile and tablet platforms.

### CROSS-REFERENCE TO RELATED APPLICATIONS

The present nonprovisional patent application claims priority from provisional application No. 61/543,300 filed Oct. 4, 2011.

### STATEMENT REGARDING FEDERALLY SPONSORED RESEARCH OR DEVELOPMENT

Not Applicable

REFERENCE TO SEQUENCE LISTING, A TABLE, OR A COMPUTER PROGRAM LISTING COMPACT DISC APPENDIX

Not Applicable

### BACKGROUND OF THE INVENTION

Before the advent of Matchfund, money management platforms designed for youth lack in one or more of these areas: (1) the interface and related art is not youth-friendly; for example, there is no dynamic feed, no game mechanics and no 2.0 look and feel, (2) the educational aspect is not integrated into the actual management platform, (3) there is no social/community functionality that allows parents, guardians, and other interested parties to actively and concurrently participate in the youth's online banking, spending, saving, charity, or financial education experience, (4) chore/allowance trackers do not integrate with real financial products, (5) youth do not earn money through activities completed on the platform, (6) money management platforms are not goal-based, (7) youth are not given the ability to make mistakes with real money, (8) youth are not presented with trade-offs between different goals, (9) youth are not shown the opportunity cost of their spending, (10) youth cannot request/formalize loans from their parents/family/loved ones.

Instead, money management platforms have been nearly identical to the platform/interface/design used for adult customers of financial institutions; they simply slap a “kid” label on adult products. Financial literacy products have been virtual- or curriculum-based; they have not been truly integrated into a money management product/platform. And chore/allowance trackers have been notional checklists and/or spreadsheets that simply log activity rather than automatically tracking activity that earns allowance money.

No other product on the market allows for youth to make informed decisions as to how to allocate their money according to 4 different goal (“fund”) types. No other product on the market creates real monetary incentives in the form of automatic matches that encourage youth to choose savings and charity over spending. No other product on the market allows for youth to make mistakes with their money, repeatedly choosing spending and neglecting established plans for short-term, long-term, and charity goals, while in doing so limits the ability for the youth to overspend (i.e. spending maximums are established by the adult custodian and money only available in the form of a match for a particular savings or charity goal cannot be diverted by the youth to the spending fund).

### BRIEF SUMMARY OF THE INVENTION

The following presents a simplified summary of one or more aspects of the present invention in order to provide a basic understanding of such aspects. This summary is not an extensive overview of all contemplated aspects, and is intended to neither identify key or critical elements of all aspects nor delineate the scope of any or all aspects. Its intent is to present some concepts of one or more aspects in a simplified form as a prelude to the more detailed description that is presented later.

Aspects of the present invention overcome problems of the status quo (as identified in the “background of the invention” section above) by providing methods and systems for online and mobile, youth-related money management. Youth earn coins by completing a variety of educational challenges. Coins are then redeemed for money in specific savings, spending and charity goals. The value of a coin is dependent upon which goal it is allocated toward, as specified by the “parent”. Methods and systems in accordance with the present invention provide easy methods for youth and adults to create and manage accounts together. The co-managed accounts can be created by a parent, grandparent, guardian or loved one (such persons interchangeably referred to herein as “a custodian” or “a parent”) for the benefit of a youth (“youth” shall be considered herein as a person under the age of thirty that shall act as the beneficiary of some or all money deposited into a Matchfund account). A variety of financial accounts can be opened, including but not limited to checking accounts, savings accounts, money market accounts, trust accounts, certificates of deposit, brokerage accounts, investment accounts, 529 Plans, 401(k) Plans, Prepaid Card accounts, Debit Card accounts, Gift Card Accounts, Virtual Currency accounts, loans, or Credit Card accounts. Deposits via direct deposit, ACH transfer, or Credit Card transfer can be established by a User's Savings Community to make one-time or recurring contributions for allowance, personal achievements, milestones, birthdays, holidays, chores, etc.

Social networking features also allow a user to share fund visibility with members of his/her Savings Community, make one-time or recurring contributions to members of his/her Savings Community, participate with members in multi-player challenges, provide advice or words of encouragement to members of a user's Savings Community.

Another aspect of the present invention includes a mobile application developed for a portable electronic device, such as a mobile telephone, Personal Digital Assistant (PDA), or tablet, for example, that lets users manage their money, track goals and progress, edit goals and deposit plans, add and remove members from a fund's visibility and/or the User's Savings Community, pay virtual bills, complete challenges, comment on activities, transfer money, or perform other traditional online banking functions.

### BRIEF DESCRIPTION OF THE SEVERAL VIEWS OF THE INVENTION

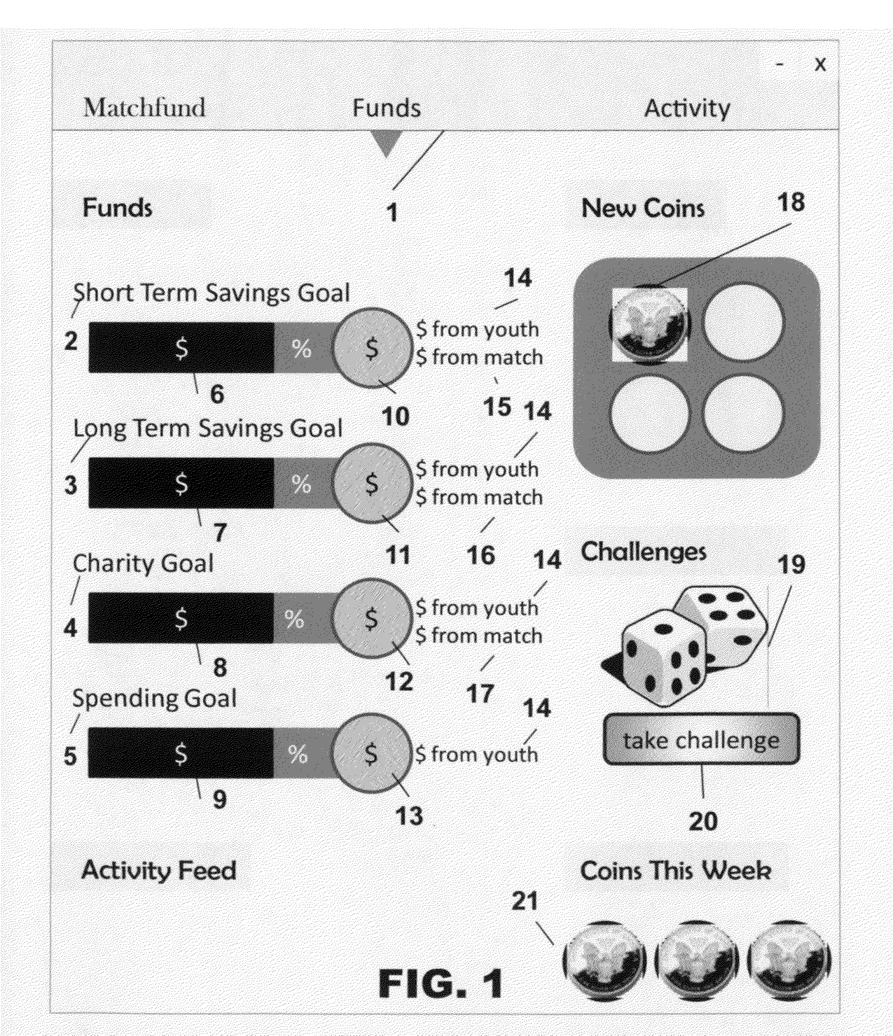

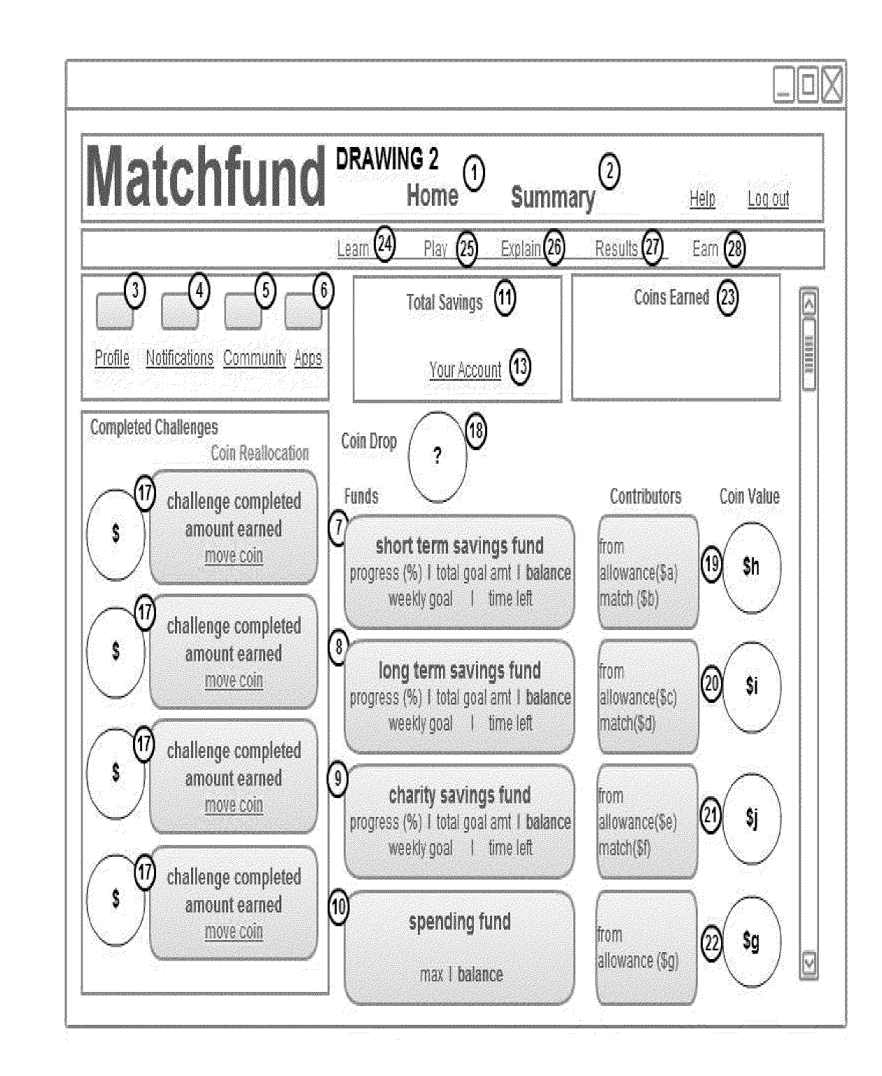

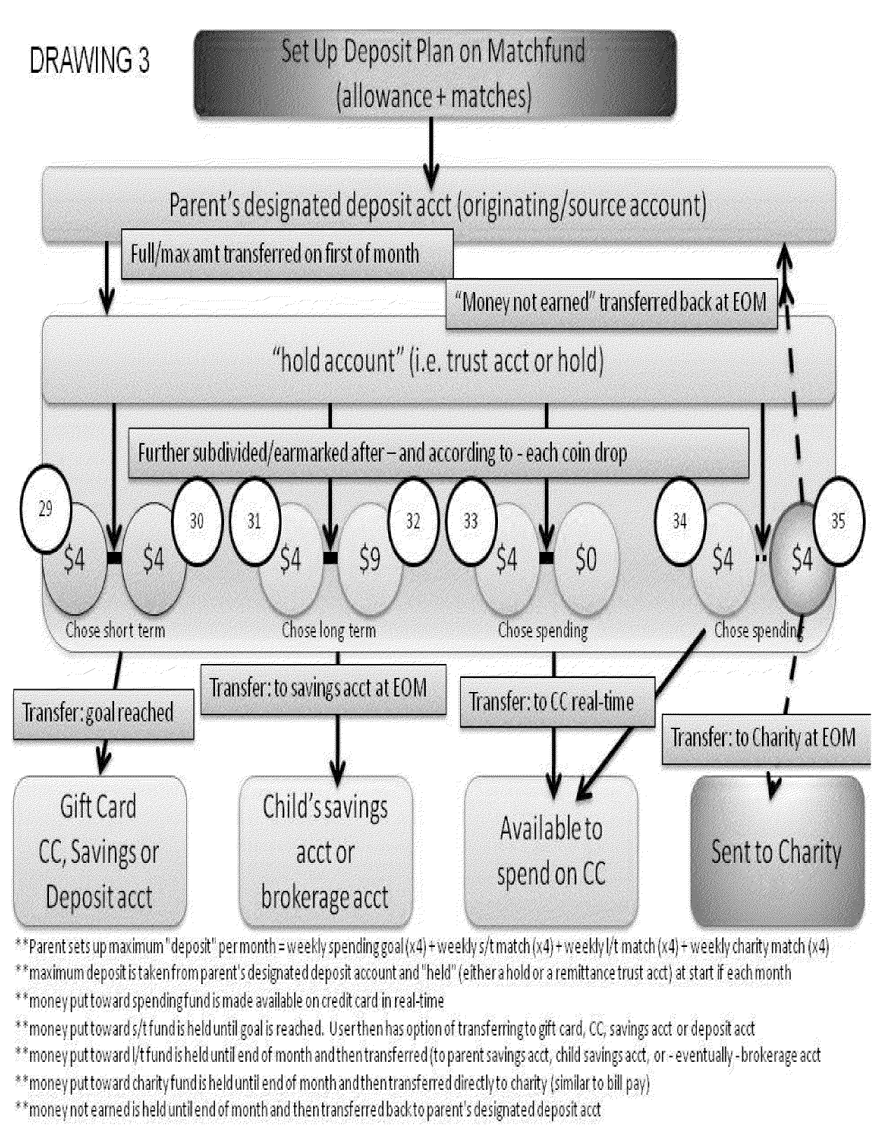

FIG. 1 shows an exemplary wireframe diagram of a personal home page (or “dashboard”) for a user, in accordance with aspects of the present invention.

Reference number 1 in FIG. 1 shows the main navigation bar with the “Funds” tab activated.

Reference number 2 in FIG. 1 illustrates the Short Term Savings Goal.

Reference number 3 in FIG. 1 illustrates the Long Term Savings Goal.

Reference number 4 in FIG. 1 illustrates the Charity Goal.

Reference number 5 in FIG. 1 illustrates the Spending Goal.

Reference number 6 in FIG. 1 is the progress bar for the Short Term Savings Goal, which display's the goal's current balance, total goal amount, percentage complete, and weekly progress as a measure of weekly goal.

Reference number 7 in FIG. 1 is the progress bar for the Long Term Savings Goal, which display's the goal's current balance, total goal amount, percentage complete, and weekly progress as a measure of weekly goal.

Reference number 8 in FIG. 1 is the progress bar for the Charity Goal, which display's the goal's current balance, total goal amount, percentage complete, and weekly progress as a measure of weekly goal.

Reference number 9 in FIG. 1 is the progress bar for the Spending Goal, which display's the goal's current balance, maximum amount, percentage toward maximum amount, and weekly progress as a measure of weekly goal.

Reference number 10 in FIG. 1 is the coin drop slot for the Short Term Savings Goal. When there is a token (or “coin”) waiting to be allocated to a goal, this coin drop slot will display the money value of that coin if it were to be allocated to the Short Term Savings Goal. The value is determined by a set of algorithms based on the youth's total weekly discretionary money and any conditional match money (“sweetener”) available on the Short Term Savings Goal.

Reference number 11 in FIG. 1 is the coin drop slot for the Long Term Savings Goal. When there is a token (or “coin”) waiting to be allocated to a goal, this coin drop slot will display the money value of that coin if it were to be allocated to the Long Term Savings Goal. The value is determined by a set of algorithms based on the youth's total weekly discretionary money and any conditional match money (“sweetener”) available on the Long Term Savings Goal.

Reference number 12 in FIG. 1 is the coin drop slot for the Charity Goal. When there is a token (or “coin”) waiting to be allocated to a goal, this coin drop slot will display the money value of that coin if it were to be allocated to the Charity Goal. The value is determined by a set of algorithms based on the youth's total weekly discretionary money and any conditional match money (“sweetener”) available on the Charity Goal.

Reference number 13 in FIG. 1 is the coin drop slot for the Spending Goal. When there is a token (or “coin”) waiting to be allocated to a goal, this coin drop slot will display the money value of that coin if it were to be allocated to the Spending Goal. The value is determined by a set of algorithms based on the youth's total weekly discretionary money. This value will always be equal to the value in Reference number 14 below.

Reference number 14 in FIG. 1 is the amount of a token's value that comes from the youth's discretionary money. This amount can be regarded as the “base value” of a coin when it is allocated to a particular goal. If/when there is a conditional match (“sweetener”) on the goal, it is this “base value” that triggers the match money in a proportion determined at setup by the user providing the match (“sweetener”).

Reference number 15 in FIG. 1 is the amount of the Short Term Savings Goal's token's value that comes from a conditional match (“sweetener”) provided by another user, if/when said match exists. The value of this match amount (“sweetener”) is calculated using an algorithm that takes into account time frames, ratios and/or total match (“sweetener”) amounts specified by the match provider.

Reference number 16 in FIG. 1 is the amount of the Long Term Savings Goal's token's value that comes from a conditional match (“sweetener”) provided by another user, if/when said match exists. The value of this match amount (“sweetener”) is calculated using an algorithm that takes into account time frames, ratios and/or total match (“sweetener”) amounts specified by the match provider.

Reference number 17 in FIG. 1 is the amount of the Charity Goal's token's value that comes from a conditional match (“sweetener”) provided by another user, if/when said match exists. The value of this match amount (“sweetener”) is calculated using an algorithm that takes into account time frames, ratios and/or total match (“sweetener”) amounts specified by the match provider.

Reference number 18 in FIG. 1 shows a token (or “coin”) that has been earned but has not yet been allocated to a specific goal. The token does not have a value in its unallocated state because the value varies depending on the goal to which it is allocated if/when there is a conditional match (“sweetener”) available on one or more of the goals. The number of unallocated coins that a youth earns for completing a given challenge is calculated using an algorithm that takes into account the youth's total weekly discretionary money.

Reference number 19 in FIG. 1 shows the Challenge area of the dashboard. Here the youth is presented with different challenges throughout the course of the week. By successfully completing these challenges, the youth earns the tokens (or “coins”) described in Reference number 18.

Reference number 20 in FIG. 1 shows the Take Challenge button. By clicking/tapping this button, the youth is taken to a challenge page where he/she can complete a variety of tasks to earn tokens to be allocated to his/her goals. Challenges vary. Examples include—but are not limited to—video tutorials, text lessons, role playing games, multiplayer games, virtual billpay, and manual transaction categorization. Challenges are designed to teach one or more concept in financial literacy and/or personal finance.

Reference number 21 in FIG. 1 shows tokens (or “coins”) that have previously been earned and allocated to a specific goal over a specified period of time. For each allocated token in this section, the user is shown the challenge that earned the token, the amount earned when the token was allocated and in which goal it was allocated.

### DETAILED DESCRIPTION OF THE INVENTION

Matchfund is a money management platform designed for youth, comprised of:
a. Four different goal types:
   i. a short-term savings fund
   ii. a long-term savings fund
   iii. a charity savings fund
   iv. a spending fund
b. An activity feed that displays the following headline activities that can be drilled down into:
   i. Financial literacy challenges waiting to be completed
   ii. Financial literacy challenges previously completed
   iii. Synopsis of coins earned
   iv. Synopsis of coin allocations
   v. Creation of a new fund
   vi. Reaching a goal in a fund
   vii. Editing a fund
   viii. Parental “Week in Review”
   ix. Adding a member to User's Community
   x. Certain activities completed by a User's Community
   xi. A monetary gift (one-time or recurring) from User's Community
   xii. Messages from a partner financial institution
   xiii. Purchases made on a User's spending card
   xiv. Creating/Editing a deposit plan
c. A Community section that allows for custom actions and visibility for each member of a User's Community, including but not limited to:
   i. Adding a member to a User's Community
   ii. Removing a member from a User's Community
   iii. Allowing a member to view a particular User fund
   iv. Disallowing a member to view a particular User fund
   v. Making a one-time monetary gift to a Community Member
   vi. Making a recurring monetary gift to a Community Member
   vii. Playing multi-player challenges with a Community Member
d. A series of challenges that the youth must successfully complete in order to earn coins. Challenges initially cover financial literacy topics. In the future, these challenges might broaden their scope to teach lessons around charity, environmentalism, global cultures/religions, etc. Each challenge generally adheres to the following flow:
   i. Learn: The youth begins each challenge with an introduction to a particular topic. This “Learn” page might be text-based, image-based, or video-based
   ii. Play: After completing the Learn page, the youth must apply the topic introduced in the form of a game-like challenge. The form of each challenge varies greatly.
   iii. Explain: The “Explain” page requires the youth to answer one or more questions in his/her own words. Questions relate to the topic of the challenge or a specific component of the Play page
   iv. Results: The “Results” page provides a score, summary, consequence, or general result of the “Play” page. In some instances, the youth is given an opportunity to retake the “Play” portion of the challenge on the Results page
   v. Earn: The “Earn” page is the culmination of each challenge. On the “Earn” page, the youth is presented with a coin that must be allocated to the youth's short-term, long-term, charity, or spending fund. The value of the coin can be different depending on which fund the coin is applied to (This is true because of the “Youth Allowance” vs. “Parent Match” value inherent in a coin's value. See sections f, g, h below for more detail). When a coin is allocated to fund, the weekly goal for that fund is reached and the fund turns gold. The fund remains gold for the remainder of the week, provided the coin is not reallocated away from that fund. At the end of the week, all coin allocations are “locked in” and begin in their normal state at the beginning of the next week. In making an informed decision, the youth is shown the following information about each of his/her funds:
      1. Fund balance
      2. Fund progress (expressed as a status bar and a percentage of total goal)
      3. Total goal amount
      4. Weekly goal amount
      5. Time (Weeks) remaining
      6. The Value of the Coin, expressed as a whole as well as “Youth Allowance” portion+“Parent Match” portion
e. Coins, once earned, are used to earn real money toward a long-term, short-term, charity or spending goal.
f. Money earned in the form of “Youth Allowance”: “Youth Allowance” is money the youth has discretion over. Youth Allowance can be allocated however the youth sees fit, between one, some or all funds/goals. Youth Allowance can be comprised of income, gifts, allowance, etc.
g. Money earned in the form of “Parent Match”: “Parent Match” money is a conditional amount of money earned toward a particular savings or charitable fund. “Parent Match” money can be given by parents, family members or loved ones. This money is only earned toward its earmarked fund when the youth contributes the necessary amount from his/her discretionary Youth Allowance. If the “Parent Match” money is not earned, it can be automatically allocated to its originally intended fund, a different fund, a “Money not Earned” fund, or can be kept in/withdrawn to the original funding account source.
h. The value of a coin is comprised of two parts:
   i. A portion of the coin value is derived from the youth's personal contribution (i.e. money allocated to a fund from the “Youth Allowance”)
   ii. A portion of the coin value is derived from an optional match amount, an amount only triggered when the youth contributes from his/her “Youth Allowance”
i. The ability for a parent, guardian or authorized Savings Community member to view a youth's completed challenges. After successfully completing a challenge, an activity is produced in the youth's activity feed as well as the activity feed of the youth's parent or guardian, as well as other Savings Community members so authorized by the parent or guardian of the youth. This “review” state allows users to review a challenge, take the challenge, read or watch the “learn” page, view the “results” page, read the question and user-generated answer on the “explain” page, and review the coin allocation chosen on the “earn” page.
j. Online banking functionality that allows both youth and adult custodian users to: (1) view accurate balances, (2) transfer money to funds, from funds and between funds, (3) withdraw fund balances to a retail gift card, debit card, credit card, prepaid card or back to the originating checking or savings account, (4) establish one-time or recurring deposits from an originating checking or savings account into one or more Matchfund funds, (4) designating deposits as “Youth Allowance”, “Parent Match” or a combinagtion thereof.
k. Fund Details pages that provide drilled down information for each of the four fund types.
   i. A Short Term Fund Details page that shows fund balance, progress, total goal amount, weekly goal amount, contribution plan divided into “Youth Allowance” and “Parent Match”, time remaining, fund icon, optional uploaded fund image, history of coin allocations, Projected Vs. Target Completion dates, fund visibility, transaction history, contribution history by contributor/amount/type/date
   ii. A Long Term Fund Details page that shows fund balance, progress, total goal amount, weekly goal amount, fund icon, optional uploaded fund image, contribution plan divided into “Youth Allowance” and “Parent Match”, time remaining, history of coin allocations, Projected Vs. Target Completion dates, fund visibility, transaction history, contribution history by contributor/amount/type/date
   iii. A Charity Fund Details page that shows fund balance, progress, total goal amount, weekly goal amount, fund icon, optional uploaded fund image, contribution plan divided into “Youth Allowance” and “Parent Match”, time remaining, history of coin allocations, Monthly synopsis of amounts reached, fund visibility, transaction history, contribution history by contributor/amount/type/date
   iv. A Spending Fund Details page that shows fund balance, fund maximum, fund icon, optional uploaded fund image, weekly spending plan, history of coin allocations, Monthly synopsis of amounts reached, spending trends month over month, fund visibility, transaction history, contribution history by contributor/amount/type/date, purchase history, purchase pie chart, purchase categorizations, an “emergency loan request” functionality for youth, and the ability to freeze/unfreeze the spending card for the custodian.
l. An Apps section that allows for adding in-house and third party apps that add value for particular end users. Examples include, but are not limited to, an allowance app, a chore app, a family loan app, a Suze Orman app, a family finances app, a family bill app.

Detailed Description of the “Earn Page” (aka “Main Dashboard” or “Coin Drop Page”): The “Earn” page is the page the user arrives at after successfully completing a challenge. Upon completion of the challenge, the user earns a coin that can be redeemed toward real money in a particular fund (short-term, long-term, charity, or spending fund). The value of this coin (i.e. the redemption value) can be different depending on the fund to which it is allocated. The primary reason for this difference is due to an optional “Parent Match” that can be attached to one or more funds. (while referred to in this specification as a “Parent Match”, this match could also be attached to a fund by another member of the youth's Savings Community; it does not need to be provided by the parent or guardian, though it does require custodial approval when the match is coming from another community member).

When establishing a deposit plan, parents and youth are meant to sit down together to identify the youth's four funds and create a contribution plan based on two types of money: (1) “Youth Allowance”, and (2) “Parent Match”. Youth Allowance is money that the youth has discretion over; the youth can spend, save or donate his/her youth allowance however he/she desires. However, there is a contribution plan for “Youth Allowance” money; this plan is a weekly amount the youth aims to spend, save for a short-term goal, save for a long-term goal, and give to charity, the sum of which equals the total Youth Allowance amount.

The “Parent Match” is designed to incent youth to adhere to their Youth Allowance plan; their Youth Allowance contribution has potential to trigger an additional Parent Match amount. The “Parent Match” also serves to underscore the opportunity cost of spending by forcing the youth to forego Parent Match amounts when he/she chooses to over-allocate coins to his/her spending fund. The “Parent Match” also provides a level of protection, ensuring that certain amounts of money can only be accumulated in savings and charity funds and cannot be spent by the youth. Finally, the “Parent Match” allows youth to make mistakes (i.e. allocating too many coins to the spending fund), a valuable lesson that allows both parents and youths to see patterns and correct behavior with limited risk of overspending.

When a user arrives at the “Earn” page, the available coin values for each of the four funds is determined by an algorithm, an algorithm based on inputs provided by the parent or custodian when setting up the Matchfund account. When creating a Matchfund account, we ask the parent for a total weekly Youth Allowance amount. This amount is the maximum amount the youth can add to his/her spending fund each week (short of requesting an emergency loan or adding a one-time gift or deposit). We then ask the parent to break down the weekly Youth Allowance into a plan made up of two parts: (1) a weekly spending goal, (2) a weekly savings and charity goal, which is then divided evenly between a weekly short-term savings goal, a weekly long-term savings goal, and a weekly charity goal. We then give parents—or other Savings Community members—the option of adding a conditional “Parent Match” amount to the youth's short-term goal, long-term goal, and/or charity goal. This “Parent Match” amount is only earned if/when the youth contributes his/her Youth Allowance portion.

Unless customized in the parent's Account Settings page, the “Parent Match” amount for any given fund can only be earned once per week. Therefore, the first time the youth earns a coin each week, the potential coin values will be:
Short-term coin value=⅓ Youth Allowance weekly savings and charity goal+Parent Match contribution to short-term fund
Long-term coin value=⅓ Youth Allowance weekly savings and charity goal+Parent Match contribution to long-term fund
Charity coin value=⅓ Youth Allowance weekly savings and charity goal+Parent Match contribution to charity fund
Spending coin value=some or all of the Youth's Weekly Spending Goal (this value can be customized by the Parent depending on how they would like the youth to earn some or all of his/her spending money. A portion can be given automatically upfront each week, divided among two coins, or earned through other means, such as chores, grades, purchase categorization, etc.)

When a coin has been successfully allocated to a particular fund, the Parent Match portion of the coin value will not be available during the next coin drop. For example, if the youth chooses to allocate his/her first coin to the short-term fund, the coin values after earning a second coin will be:
Short-term coin value=⅓ Youth Allowance weekly savings and charity goal
Long-term coin value=⅓ Youth Allowance weekly savings and charity goal+Parent Match contribution to long-term fund
Charity coin value=⅓ Youth Allowance weekly savings and charity goal+Parent Match contribution to charity fund
Spending coin value=some or all of the Youth's Weekly Spending Goal (this value can be customized by the Parent depending on how they would like the youth to earn some or all of his/her spending money. A portion can be given automatically upfront each week, divided among two coins, or earned through other means, such as chores, grades, purchase categorization, etc.)

When a youth allocates a coin to a short-term, long-term, or charity fund, the weekly goal for that fund is satisfied. To denote this achievement, the fund turns gold. It remains gold throughout the course of the week, unless a coin is moved/reallocated or until the end of the week, at which point it resets for the next week going forward. Parent Matches will continue to be depleted throughout the course of the week, provided the youth triggers these matches by contributing his/her weekly contribution to a given fund. Any unearned Parent Match amounts will be handled as the parent chooses. Options include, but are not limited to: (1) allocating the money to its intended fund, (2) allocating the money to a different fund, (3) withdrawing the money back to the source account, (4) not transferring the money from the source account, (5) holding the money in a temporary “holding account” until a future date. The aforementioned “holding account” might be a remittance trust account, a pooled customer account, a designated customer's account, or some other type of account.

During the course of the week, the youth has the ability to move coins that he/she earned earlier in the week. To reallocate a coin, the youth navigates to the “Summary” page and clicks on a “move this coin” button next to an earned coin. The youth's Summary page then becomes a “Coin Drop”, nearly identical to the “Earn” page at the end of a challenge.

On the final day of the week, all earned coins become “locked in”, which means that the coin allocations become permanently attributed to the funds to which they've been allocated. The next week then begins fresh, with all weekly Parent Matches restored for the week.

Detailed Description of the Matchfund Deposit and Allocation Flow: When creating an account, custodial users set up a monthly deposit plan that encompasses Youth Allowance money and Parent Match money. The sum of these two parts constitutes the automatic, recurring monthly deposit that will be transferred from a custodial originating account to a Matchfund-compatible account on a monthly date specified by the custodian creating the Matchfund account. The Matchfund-compatible account (herein referred to as a “hold account”) can be a financial account at a partner financial institution, including but not limited to: a temporary holding account, a trust account, a remittance trust account, a Matchfund customer pooled account, a checking account, a savings account, a certificate of deposit, an investment account, a brokerage account, a 529 Plan, a money market account, etc. Alternatively, Matchfund might simply put a hold on the custodial originating account in the full amount of the Matchfund monthly obligation.

As money is allocated (i.e. coins are earned and applied to particular funds), back-end transfers occur in one of a number of ways:
When a coin is applied to the spending fund, the dollar amount is made available to spend on the Matchfund spending card. This might be, though not limited to, an amount loaded on to a prepaid card, an amount made available on a debit card, or an amount added to a credit limit on a credit card.
When a coin is applied to the short-term savings fund, the coin value is retained in the Matchfund hold account, though the amount is earmarked for the short-term savings goal. This amount can be held in the hold account until the goal amount is reached or it can be transferred to a destination account at predetermined intervals (for example, the end of each month).
When a coin is applied to the long-term savings fund, the coin value is retained in the Matchfund hold account, though the amount is earmarked for the long-term savings goal. This amount can be held in the hold account until the goal amount is reached or it can be transferred to a destination account at predetermined intervals (for example, the end of each month).
When a coin is applied to the charity fund, the coin value is retained in the Matchfund hold account, though the amount is earmarked for the charity goal. This amount can be held in the hold account until the goal amount is reached or it can be transferred to a destination account or directly to the charitable organization at predetermined intervals (for example, the end of each month).
Any “Parent Match” money that is not earned by the youth will be handled according to the custodian's instructions. Options include, but are not limited to: (1) allocating the money to its intended fund, (2) allocating the money to a different fund, (3) withdrawing the money back to the source account, (4) not transferring the money from the source account, (5) holding the money in a temporary “holding account” until a future date. The aforementioned “holding account” might be a remittance trust account, a pooled customer account, a designated customer's account, or some other type of account.

What is claimed is:

1. A method of online money management, comprising: creating at least one financial goal; earning at least one token by completing at least one task; redeeming the token for progress toward a total monetary goal in said financial goal.

2. The method according to claim 1, wherein the financial goal comprises of a goal name, a total monetary goal, and a current balance.

3. The method according to claim 1, further comprising: linking the financial goal to a back-end financial product.

4. The method according to claim 1, wherein the financial goal is a savings goal.

5. The method according to claim 1, wherein the financial goal is a spending goal.

6. The method according to claim 1, wherein the financial goal is a charity goal.

7. The method according to claim 3, wherein the financial product is co-managed by at least one adult and at least one minor.

8. The method according to claim 7, further comprising: facilitating the sharing of at least one financial goal with a select member of a user's online community.

9. The method according to claim 7, wherein the adult makes select amounts of money available to the minor by means of completing said tasks.

10. The method according to claim 1, wherein progress in the financial goal is a monetary amount.

11. The method according to claim 1, wherein progress in the financial goal is a percentage amount of the total monetary goal.

12. A method of teaching financial literacy, comprising: completing at least one educational task; earning at least one token upon completion of said task; allocating the token to a financial goal in order to make progress toward a total monetary goal in said financial goal.

13. The method according to claim 12, wherein the task is playing a game.

14. The method according to claim 12, wherein the task is watching a video.

15. The method according to claim 12, wherein the task is reading a topic on financial literacy.

16. A method of determining a token's value when it is allocated to a financial goal, comprising: creating at least one financial goal; establishing a means by which a token is earned; assigning a minimum value to the token when it is allocated to a financial goal; adding additional value to the token when it is allocated to a financial goal with a sweetener associated with said goal.

17. The method according to claim 16, further comprising: exhausting the financial goal's sweetener for a period of time.

18. The method according to claim 16, wherein the amount of the sweetener is derived from the token's minimum value.

19. The method according to claim 16, wherein the amount of the sweetener is expressed as a flat monetary amount.

20. The method according to claim 16, wherein the amount of the sweetener is expressed as an amount proportional to the total monetary goal.
